(19) United States
(12) Patent Application Publication
(10) Pub. No.: US 2012/0176327 A1
(43) Pub. Date: Jul. 12, 2012

(54) TOUCH INTERFACE SYSTEM AND METHOD

(75) Inventors: Han-Sik NA, Goyang-si (KR); Choon-Shik LEE, Seoul (KR)

(73) Assignee: PANTECH CO., LTD., Seoul (KR)

(21) Appl. No.: 13/338,763

(22) Filed: Dec. 28, 2011

(30) Foreign Application Priority Data
Jan. 6, 2011 (KR) 10-2011-0001489

(51) Int. Cl. G06F 3/041

(52) U.S. Cl. 345/173

(57) ABSTRACT

A touch interface system and a method for providing a touch interface by detecting a change in a pixel characteristic in a pixel selected with a sensing terminal. The touch interface system includes the sensing terminal to select a location corresponding to a pixel on a display unit, and a display processing module to change a pixel characteristic of the selected pixel to generate a processed pixel on the display unit. The sensing terminal in response recognizes the pixel with a changed pixel characteristic as the processed pixel, and the display processing module communicates with the sensing terminal to determine the location of the processed pixel. Accordingly, the location of the processed pixel may be received as a user input.

### CROSS-REFERENCE TO RELATED APPLICATION

This application claims priority from and the benefit under 35 U.S.C. §119(a) of Korean Patent Application No. 10-2011-0001489, filed on Jan. 6, 2011, which is incorporated herein by reference for all purposes as if fully set forth herein.

### BACKGROUND

1. Field

The following description relates to an input technology suitable to an electronic device, and more particularly, to a touch interface.

2. Discussion of the Background

Various electronic devices have been developed with improved electronic communication technology with a focus on device design as well as manipulation convenience. In this regard, various input devices, such as keyboards and keypads have received attention. As a result, the typical input device, which may generally be involved in data processing procedures, has been integrated with the display operation to develop a touch panel or a touch sensing input device.

Conventionally, the touch sensing input device may use an additional resistance film or hardware to implement a touch input capability in an electrostatic fashion on the electronic device. In this case, cost of hardware to implement electrostatic touch capability and probability of defects may increase with the size of the display device. Further, the additional installation of hardware on the device implementing electrostatic touch capability may cause increase in weight and volume of the device.

### SUMMARY

Exemplary embodiments of the present invention provide a system and method for implementing a touch interface.

Additional features of the invention will be set forth in the description which follows, and in part will be apparent from the description, or may be learned by practice of the invention.

Exemplary embodiments of the present invention provide a touch interface system including a sensing terminal to recognize a processed pixel based on a change in a pixel characteristic, and to transmit time at which the processed pixel is recognized; and a display processing module to generate the processed pixel on a display unit, to display a frame corresponding to the processed pixel, and to calculate a location of the processed pixel at the time at which the processed pixel recognition time is received from the sensing terminal.

Exemplary embodiments of the present invention provide a touch interface method including synchronizing a display processing module with a sensing terminal; generating a processed pixel, in which the processed pixel has its characteristic changed; displaying a frame corresponding to the processed pixel; and calculating a location of the processed pixel.

Exemplary embodiments of the present invention provide a touch interface method including synchronizing a display processing module with a sensing terminal; selecting a first pixel at a first pixel location using the sensing terminal; generating a first processed pixel at the first pixel location, in which the pixel at the first pixel location has its characteristic changed to form the first processed pixel; displaying a first frame corresponding to the first processed pixel; calculating a location of the first processed pixel; selecting a second pixel at a second pixel location using the sensing terminal; generating a second processed pixel at the second pixel location; updating the display of the first frame with a second frame corresponding to the second processed pixel; and calculating a second location of the second processed pixel.

It is to be understood that both foregoing general descriptions and the following detailed description are exemplary and explanatory and are intended to provide further explanation of the invention as claimed. Other features and aspects may be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a figurative diagram illustrating a touch interface system according to an exemplary embodiment of the invention.

FIG. 2 is a schematic diagram illustrating a display processing module according to an exemplary embodiment of the invention.

FIG. 3 is a diagram illustrating frame images corresponding to processed pixels according to an exemplary embodiment of the invention.

FIG. 4A and FIG. 4B are diagrams illustrating an image with a plurality of processed pixels and frames according to an exemplary embodiment of the invention.

FIG. 5 is a diagram illustrating a frame with a processed pixel selected by a sensing terminal according to an exemplary embodiment of the invention.

FIG. 6 is a schematic diagram illustrating a sensing terminal according to an exemplary embodiment of the invention.

FIG. 7 is a flowchart illustrating a method for recognizing a touch input according to an exemplary embodiment of the invention.

### DETAILED DESCRIPTION OF THE ILLUSTRATED EMBODIMENTS

The invention is described more fully hereinafter with references to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity, illustration, and convenience.

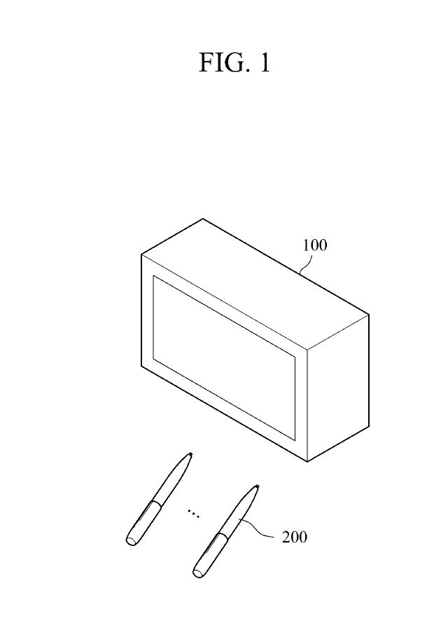

FIG. 1 is a figurative diagram illustrating a touch interface system according to an exemplary embodiment of the invention.

As shown in FIG. 1, the touch interface system includes an apparatus 100 and one or more sensing terminals 200. In an example, the apparatus 100 may be a notebook computer, a mobile terminal, a tablet computer, a smart TV, personal digital assistant, and other similar devices that may be able to receive a user input.

The apparatus 100 may include a display unit, which may include a general liquid crystal display (LCD) or organic light-emitting display (OLED), to display an image using pixel signals. The display unit may include a picture unit that forms a display area, which may be used to display pixels representing luminance and colors. The pixels may be arranged in a matrix or other similar structures. In addition, a front surface of the picture unit may include a protective cover, which may be implemented with the picture unit. The protective cover may be made of glass, plastic, or other similar materials and may be integrated in the picture unit. The apparatus 100 may also include a display processing module to implement a touch interface. In an example, the display module may be a software module, a hardware processor, or a combination of both.

The sensing terminal 200 may include a sensor to detect a change in a pixel characteristic of one or more pixels displayed on the display unit of the apparatus 100. In an example, the pixel characteristic may include, without limitation, luminance, brightness, color, color saturation and the like. Accordingly, the sensing terminal 200 may recognize a processed pixel by detecting a change in the pixel characteristic of one or more pixels. Further, once the processed pixel is recognized, the sensing terminal 200 may transmit information related to the recognized processed pixel or processed pixel recognition information to the apparatus 100. Although the sensing terminal 200 is illustrated in a pen shape as illustrated in FIG. 1, the sensing terminal 200 is not limited to the respective shape and may vary in shape and size.

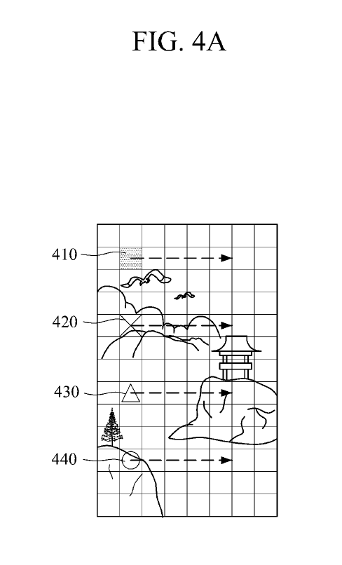

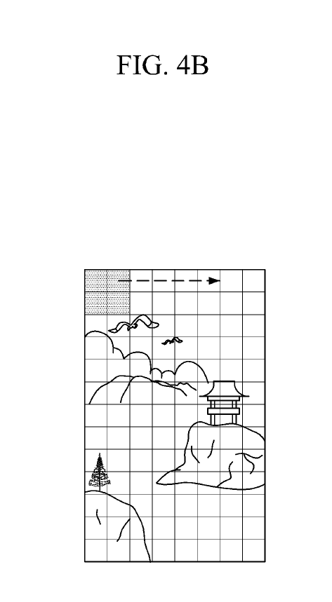

The processed pixel recognition information may include, without limitation, processed pixel pattern information and processed pixel recognition time information. The processed pixel pattern information may be information related to identify a plurality of processed pixels that has joined to form an aggregate pixel according to an area division method as illustrated in FIG. 4A and FIG. 4B. Also, the processed pixel recognition time information may refer to a point in time at which a pixel is recognized as a processed pixel.

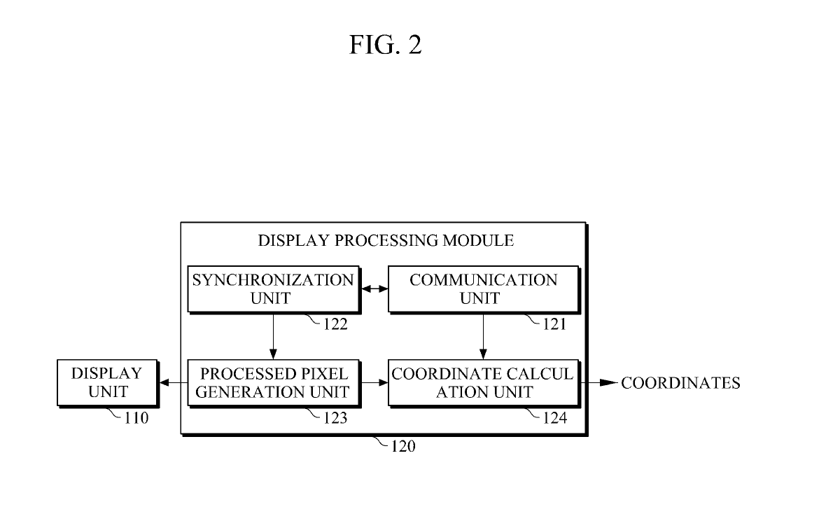

FIG. 2 is a schematic diagram illustrating a display processing module according to an exemplary embodiment of the invention.

As shown in FIG. 2, the display processing module 120 includes a communication unit 121, a synchronization unit 122, a processed pixel generation unit 123, and a coordinate calculation unit 124.

The communication unit 121 may receive and transmit a communication signal from and to the sensing terminal 200, a wired communication source or a short range wireless communication source. The short range wireless communication may include an infrared communication (IRDA®), ZigBee®, Bluetooth®, WiFi, ultra wideband® (UWB), near field communication (NFC), and ANT+®.

The synchronization unit 122 may be used to synchronize the apparatus 100 with the sensing terminal 200. More specifically, the apparatus 100 and the sensing terminal 200 may synchronize using the synchronization unit 122, which may transmit and receive communication signals to and from the apparatus 100 using the communication unit 121.

The processed pixel generation unit 123 may generate a processed pixel and output the generated pixel to the display unit. The processed pixel may be generated by changing a pixel characteristic, which may include luminance, brightness, color, color saturation, and the like. The processed pixel may accordingly be distinguished from the other adjacent pixels.

The coordinate calculation unit 124 may synchronize with the sensing terminal 200. In addition, the coordinate calculation unit 124 may receive information related to the processed pixel, which corresponds to a pixel at a touched location by the sensing terminal 200, recognize a frame corresponding to the processed pixel, and calculate coordinate value of the processed pixel included in the frame.

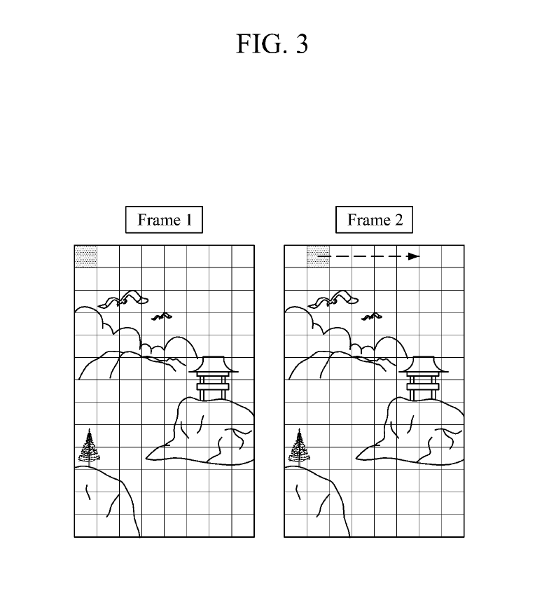

FIG. 3 is a diagram illustrating frame images corresponding to processed pixels according to an exemplary embodiment of the invention.

Referring to FIG. 3, a processed pixel, which may have a changed pixel characteristic, is included in the displayed image. The pixel size for the processed pixel may be configured to have a size recognizable by the sensing terminal 200 but virtually invisible to human eyes. In an example, the pixel size for the processed pixel may be adjusted according to a user input or automatically based on one or more reference conditions (e.g., size of the screen or image).

In addition, the image in which the processed pixel is generated may be referred to as a frame. The frame corresponding to the processed pixel may be updated at reference time intervals. If the processed pixel changes in its location from the original location to a new location, the image may be updated with a new frame that corresponds to the new location of the processed pixel. More specifically, referring to the example illustrated in FIG. 3, frame 1 may refer to a frame of the image generated at an initial time point with respect to an initial processed pixel location, and frame 2 may refer to a frame of the image generated at a different time point with respect to a different processed pixel location. In this case, it is noted that a location of the processed pixel is changed sequentially in the frame 1 and frame 2 of the image in a direction as represented by arrow. While the FIG. 3 illustrates sequential change in the location of the processed pixels, location change may also be disjunctive or random and is not limited to the sequential changes.

In addition, each frame may correspond to one or more processed pixel locations on an image. Accordingly, the updating of frames may enable each pixel included in the image to be selected as a processed pixel. For example, if each pixel has a corresponding frame of the image, and the image has N number of pixels, N number of frames may be generated to correspond to the N number of pixels on the image. Accordingly, if a user touches a desired location on the screen using the sensing terminal 200, the selected pixel corresponding to the touched location may be processed to provide the processed pixel and display the frame of the image corresponding to the processed pixel. In an example, the frame may correspond to the selected pixel, the processed pixel or both.

Thus, the sensing terminal 200 may wait for the selected pixel to become a processed pixel at the touched location. As a result, the sensing terminal 200 may recognize the processed pixel and the apparatus 100 may display the corresponding frame of the image. In addition, since frames are updated at high speeds, the user may be unaware of any delay between the changing of the frames.

Moreover, the processed pixel present in each frame may correspond to the touched location. The pixel at the touched location and the corresponding processed pixel may have the same or similar coordinates. Referring to the example illustrated in FIG. 3 again and an x-y coordinate system with lower left hand corner as the origin (0,0), coordinates of the processed pixel present in the frame 1 may be (1, 13), and coordinates of the processed pixel present in the frame 2 may be (2, 13).

In addition, the location of the processed pixel may be changed sequentially, disjunctively, and/or randomly. For example, coordinates of the processed pixel present in the frame 1 may be (1, 2), and coordinates of the processed pixel present in the frame 2 may be (2, 5). However, for simplicity in disclosure, the illustrative figures will be described with sequential movement of the processed pixels.

Further, since a wide or a high-resolution display unit may have a larger number of pixels, the sensing terminal 200 may process more than one touched location at a time. Thus, as illustrated in FIG. 4A and FIG. 4B, an image including a plurality of processed pixels and frames may be generated.

FIG. 4A and FIG. 4B are diagrams illustrating an image with a plurality of processed pixels and frames according to an exemplary embodiment of the invention.

Referring to the example illustrated in FIG. 4A, the processed pixel generation unit 123 may divide a display screen into a reference number of sections. The number of sections, size, and location may be selected by a user or automatically defined based on one or more reference conditions. Referring to FIG. 4A, the image may be divided into four sections, which correspond to processed pixels 410, 420, 430, and 440. Further, each section may have a corresponding frame for that section. In an example, if one of the divided sections includes 24 pixels, 24 corresponding frames will be present for the respective section. Accordingly, if pixel 410, 420, 430, and 440 were initially selected at the illustrated locations and then only pixel 410 is moved to a different location, only the frame corresponding to the pixel 410 may be updated. The other three frames corresponding to pixels 420, 430, and 440 will not be updated. Thus, only the frames corresponding to the changed pixel location may be updated.

Referring to the example illustrated in FIG. 4B, a plurality of neighboring pixels on an image may be selected as a single aggregate pixel to be processed to generate an aggregate processed pixel, which may have a single corresponding frame. While the aggregate pixels may be larger than individual pixels, the aggregate pixels may be within a size range that may not be visually perceived by a user. As illustrated in FIG. 4B, four adjacent pixels may form an aggregate processed pixel. Accordingly, if the sensing terminal touches a pixel corresponding to one of individual pixels forming the aggregate pixels and then selects an adjacent pixel belonging to the same aggregate pixel, the frame corresponding to the selected aggregate pixel will not be updated. Although not illustrated, individual pixels not belonging to an aggregate pixel may be present along with pixels corresponding to one or more aggregate pixels. Thus, by associating individual pixels to one or more aggregate pixels the number of frames and delay in recognition of processed pixels may be reduced.

Referring again to FIG. 2, the coordinate calculation unit 124 may receive coordinate value information corresponding to a processed pixel from the processed pixel generation unit 123, and receive processed pixel recognition information transmitted from the sensing terminal 200 via the communication unit 121. Accordingly, the coordinate calculation unit 124 may calculate and output the coordinate value information for the processed pixel included in the corresponding frame.

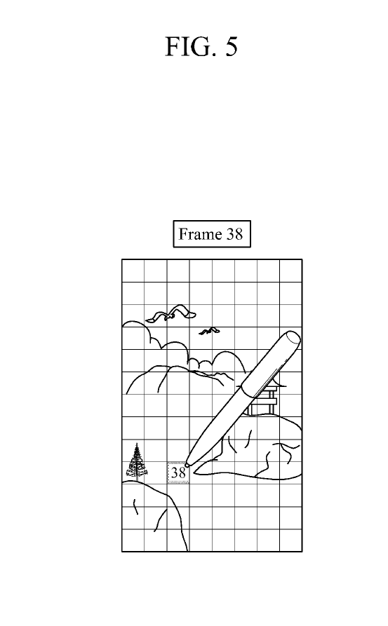

FIG. 5 is a diagram illustrating a frame with a processed pixel selected by a sensing terminal according to an exemplary embodiment of the invention.

Referring to FIG. 5, if the sensing terminal 200 touches a specific location on an image, a pixel corresponding to the touched location may be processed to produce a processed pixel. Here, the processed pixel may be an individual pixel or an aggregate pixel corresponding to a frame 38. The processed pixel recognition information is transmitted from the sensing terminal 200.

In response, the coordinate calculation unit 124, which may be synchronized with the sensing terminal 200, may receive the processed pixel recognition information for the processed pixel, recognize frame 38 as the corresponding frame, and calculate coordinate value of the processed pixel included in frame 38. The coordinate value output from the coordinate calculation unit 124 may be used as user input value to perform various processing operations of the apparatus 100.

For simplicity in disclosure, it is assumed that the reference image is displayed on the entire display of the apparatus 100 but is not limited thereto. Further, although example of frames have been described with reference to images, the described operations are not limited thereto and may apply to the screen of the apparatus 100 without respect to any particular image or object.

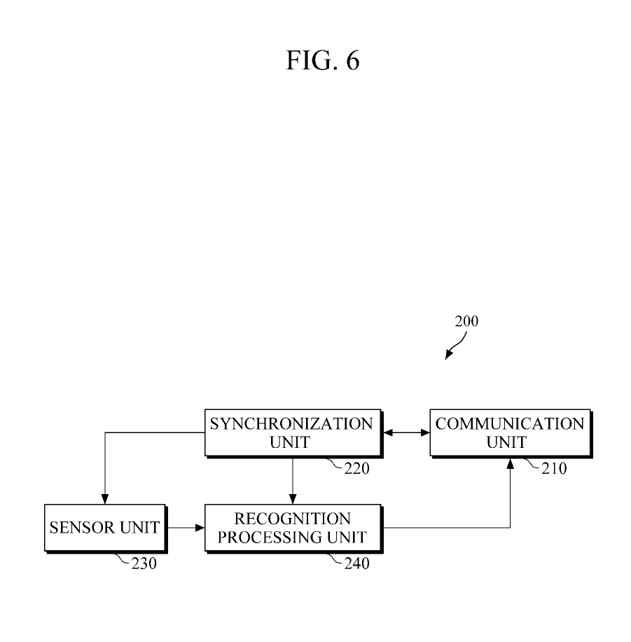

FIG. 6 is a schematic diagram illustrating a sensing terminal according to an exemplary embodiment of the invention.

Referring to FIG. 6, the sensing terminal 200 includes a communication unit 210, a synchronization unit 220, a sensor unit 230, and a recognition processing unit 240.

The communication unit 210 may process, receive, and transmit a signal from and to the display processing module 120 of FIG. 2, a wired communication source, or a short range wireless communication source. In an example, short range wireless communication may include an infrared communication (IRDA®), ZigBee®, Bluetooth®, WiFi, ultra wideband® (UWB), near field communication (NFC), and ANT+®.

The synchronization unit 220 may synchronize the sensor terminal 200 with respect to time or time-synchronize with the display processing module 120, for example, as shown in FIG. 2. Accordingly, the synchronization unit 220 may carry out time-synchronization by transmitting and receiving signals to and from the display processing module 120 using the communication unit 210.

The sensor unit 230 may be an optical sensor to detect a change in a pixel characteristic of a pixel displayed on the display unit 110 (see FIG. 2). In an example, the pixel characteristic may include luminance, brightness, color, and color saturation of the pixel. If the sensing terminal 200 and the apparatus 100 are synchronized, the sensor unit 230 may output a processed pixel recognition signal or a signal related to the recognized processed pixel to the recognition processing unit 240. In response to the reception of the processed pixel recognition signal from the sensor unit 230, the recognition processing unit 240 may generate processed pixel recognition information, and transmit the generated information to the display processing module 120 using the communication unit 210.

The processed pixel recognition information may include, without limitation, processed pixel pattern information and processed pixel recognition time information. The processed pixel pattern information may be information related to identify a plurality of processed pixels that has joined to form an aggregate pixel according to an area division method as illustrated in FIG. 4A and FIG. 4B. Also, the processed pixel recognition time information may refer to a point in time at which a pixel is recognized as a processed pixel.

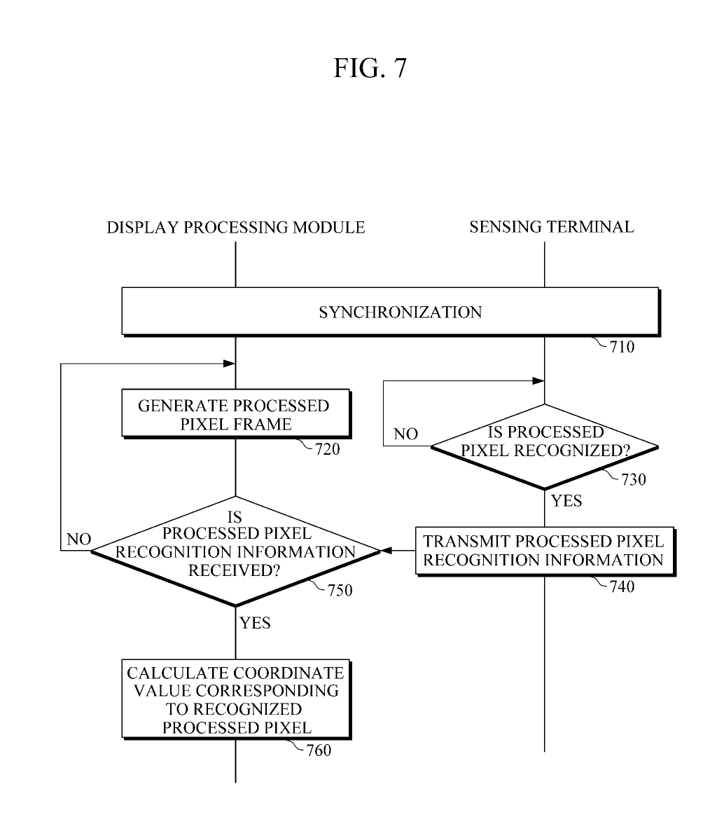

FIG. 7 is a flowchart illustrating a method for recognizing a touch input according to an exemplary embodiment of the invention.

Referring to FIG. 7, in operation 710, a display processing module and a sensing terminal are synchronized. In operation 720, the display processing module generates a frame including a processed pixel and outputs the generated frame to the display unit. The frame is updated at reference intervals, and a location of the processed pixel included in each frame may be sequentially, disjunctively, or randomly changed. The initial location of the processed pixel may correspond to a location initially touched by the sensing terminal. For example, if each frame includes one pixel and N pixels are displayed on a screen displaying an image, N number of frames may be generated corresponding to the number of pixels displayed on the screen. Thus, after N number of frames is generated, any frame within that range of frames may be repeatedly generated to correspond to the selected pixel or the processed pixel. However, since the frames are updated at such a high speed that a user may be unaware of the updating of the frames. More specifically, if the user touches a desired location on the screen using the sensing terminal, the frame including the selected processed pixel may be generated at the touched location. That is, for example, as shown in FIG. 5, if the sensing terminal initially touches the screen at the location of a pixel, frame 38 of FIG. 5 may be generated. Once frame 38 is generated, the sensing terminal may recognize the processed pixel at the touched location. Thus, the sensing terminal determines whether the processed pixel is recognized in operation 730.

In response to the determination result indicating that the processed pixel is recognized, the sensing terminal generates processed pixel recognition information and transmits the information to the display processing module in operation 740. In this case, the processed pixel recognition information may include processed pixel recognition time information and processed pixel pattern information. The processed pixel recognition time information may refer to a point in time at which a pixel is recognized as a processed pixel. The processed pixel pattern information may refer to an aggregation of pixels or division of sections of the image or a screen.

In operation 750, the display processing module may determine whether the processed pixel recognition information was received from the sensing terminal.

If it is determined that the processed pixel recognition information has not been received, the display processing module repeats operation 720. If the determination result indicates that the processed pixel recognition information has been received, the display processing module 120 calculates a coordinate value of the processed pixel using the received processed pixel recognition information in operation 760. That is, a frame corresponding to the processed pixel is generated and displayed, and a coordinate value of the processed pixel included in the recognized frame is calculated. The coordinate value calculated through the above procedures may be used as user input information.

As described above, a touch interface may be implemented without modification of hardware in the display device, and thus the touch interface may be implemented in various devices having a touch interface, including a smart pad, a smart tab, smart TVs, and wide display devices. Further, since a hardware change may not be required in the display device, the touch interface may easily be applied to a smart portable device.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A touch interface system, comprising:
a sensing terminal to recognize a first processed pixel based on a change in a pixel characteristic, and to transmit a time at which the first processed pixel is recognized; and
a display processing module to generate the first processed pixel on a display unit, to display a first frame corresponding to the first processed pixel, and to calculate a first location of the first processed pixel at the time at which a first processed pixel recognition time is received from the sensing terminal.

2. The system of claim 1, wherein the first processed pixel corresponds to a first pixel touched by the sensing terminal.

3. The system of claim 1, wherein the display processing module is a software module mounted in an apparatus comprising the display unit.

4. The system of claim 1, wherein the pixel characteristic comprises at least one of luminance, brightness, color, and color saturation.

5. The system of claim 1, wherein the display processing module calculates a coordinate of the first processed pixel.

6. The system of claim 1, wherein the display processing module further comprises:
a communication unit to transmit and receive a signal to and from the sensing terminal;
a synchronization unit to synchronize with the sensing terminal using the communication unit;
a processed pixel generation unit to generate the first processed pixel on the display unit; and
a coordinate calculation unit to calculate coordinates of the first processed pixel generated at the time the first processed pixel was recognized.

7. The system of claim 6, wherein the communication unit is further configured to transmit and receive a signal from a wired communication source or a short range wireless communication source.

8. The system of claim 1, wherein the display processing module is further configured to update the displayed first frame with a second frame corresponding to a second processed pixel.

9. The system of claim 1, wherein the sensing terminal comprises:
a communication unit to transmit and receive a signal to and from the display processing module;
a synchronization unit to synchronize with the display processing module using the communication unit;
a sensor unit to recognize the first processed pixel generated on the display unit based on a change in a pixel characteristic; and
a recognition processing unit to transmit the time at which the first processed pixel is recognized to the display processing module.

10. The system of claim 9, wherein the sensing terminal comprises an optical sensor.

11. A touch interface method, comprising:
synchronizing a display processing module with a sensing terminal;
generating a first processed pixel, wherein the first processed pixel comprises a changed pixel characteristic;
displaying a first frame corresponding to the first processed pixel; and
calculating a first location of the first processed pixel.

12. The method of claim 11, further comprising updating the first frame with a second frame corresponding to a second processed pixel at a reference time interval.

13. The method of claim 11, wherein the pixel characteristic comprises at least one of luminance, brightness, color and color saturation.

14. The method of claim 11, further comprising changing the first location of the first processed pixel, wherein the changing of the first location of the first processed pixel comprises changing the first location of the first processed pixel sequentially to a second location on the display unit for generating a second processed pixel.

15. The method of claim 11, wherein the calculating the first location of the first processed pixel comprises calculating coordinate of the first processed pixel.

16. A touch interface method, comprising:
synchronizing a display processing module with a sensing terminal;
selecting a first pixel at a first pixel location using the sensing terminal;
changing a pixel characteristic of the first pixel for generating a first processed pixel;
displaying a first frame corresponding to the first processed pixel;
calculating a first location of the first processed pixel;
selecting a second pixel at a second pixel location using the sensing terminal;
changing a pixel characteristic of the second pixel for generating a second processed pixel;
updating the display of the first frame with a second frame corresponding to the second processed pixel; and
calculating a second location of the second processed pixel.
